(19) United States
(12) Patent Application Publication
(10) Pub. No.: US 2017/0090194 A1
(43) Pub. Date: Mar. 30, 2017

(54) System And Method For Subtractive Augmented Reality And Display Contrast Enhancement

(71) Applicant: Jack Hayes, Dublin (IE)

(72) Inventor: Jack Hayes, Dublin (IE)

(73) Assignee: Halo Augmented Reality Ltd., Dublin (IE)

(21) Appl. No.: 15/275,384

(22) Filed: Sep. 24, 2016

Related U.S. Application Data
(60) Provisional application No. 62/222,938, filed on Sep. 24, 2015.

(51) Int. Cl. G02B 27/01; G06T 19/00; G09G 5/10; G06F 3/01; G06T 5/00

(52) U.S. Cl. CPC G02B 27/0101; G02B 27/0172; G06F 3/013; G06T 5/009; G09G 5/10; G06T 19/006; G02B 2027/0118; G02B 2027/0138; G02B 2027/014; G02B 2027/0178; G09G 2360/144; G09G 2320/08

(57) ABSTRACT

A subtractive augmented reality display system may include one or more light emitting displays, an optical system with which the user can view the ambient scene and the light emitted from the display(s) and a material in the way of the user's line of sight to the ambient scene which changes color, darkens or lightens based on interaction with light from the display system.

### CROSS-REFERENCE TO RELATED APPLICATIONS

This application claims priority to U.S. Provisional Patent Application 62/222,938, filed Sep. 24, 2015, which is incorporated herein by reference.

### FIELD OF SOME EMBODIMENTS OF THE INVENTION

The field of the invention relates to transparent or substantially see-through display systems which allow a viewer or viewers to see both digital or computer-produced images and the real world. It relates in particular to the field of augmented reality systems and more specifically again to augmented reality head-mounted display and computer systems.

### BACKGROUND

There is an issue encountered with see-through displays not encountered with the non-see through televisions, computer monitors and other displays; the turning off or dimming of regions of the display, usually the pixels, creates shadows and dark areas on a television but will leave a transparent region on the see-through display. Without dark parts being created on a transparent display, the effects like shadows which are taken for granted on televisions can't be displayed and among other things the augmented reality may lose realism. There have been a few attempts to create dark or black pixels on a see-through display, using a transmissive LCD display and polarisers to block light in certain regions. Problems with this method include only having less than 50% of ambient light (one polarisation) making it through the display even without any dark pixels being active and the need for a separately addressable large form-factor display besides the more favoured micro displays. On the other hand, filters like photochromic “transition” lens glasses, switchable polariser filters and electrochromic filters may darken the ambient scene as a whole to improve the contrast for the display images but lack the ability to create dark pixels.

Vuzix LCD backing [U.S. Pat. No. 6,559,813 B1] this can be used in a system to create subtractive augmented reality but the use of a separate LCD display requires more electronic parts, including at least two displays and it can create a pixelated and blurry view of the outside world because of the individual liquid crystal cells don't disappear even when the system is turned off. The invention cannot easily create both additive (such as colour video) and subtractive (virtual shadows and other graphics) using just a single display. This invention's display may not be placed off-axis and combined into the user's field of view with a combiner such as a waveguide or half-silvered mirror. The use of an LCD panel can cause pixel-wise unwanted diffraction, blurriness or other effects even when the subtractive system is turned off but the head-mounted display still worn. Microsoft possesses an invention [9,112,053] also for using LCD for subtractive augmented reality and relaying image patent [patent number] requires the use of two lenses which increases system bulk, particularly if trying to focus near objects onto the on-axis LCD and in most cases requires that the focus of the lenses be tunable to match the focus distance of the user's eyes. These inventions also suffer from keeping the pixilation, “screen door” and diffraction effects even when the system is turned off similar to the Vuzix invention. John Mac Namara [patent US20130128230 A1] also invented an LCD display system for occlusion. Magic Leap [US20150241700 A1] claims the use of LCDs as an option in their patent.
Maimone & Fuchs [“Computational Augmented Reality Eyeglasses” ISMAR 2013] used multiple LCD panels which could be used to occlude ambient light but still suffered from the abovementioned unwanted effects even when the system was turned off.
Kiyokawa et al. [“An Occlusion-Capable Optical See-through Head Mount Display” DOI: 10.1109/ISMAR.2003.1240696] required diverting the ambient light to an off-axis display (spatial light modulator). This could result in long optical trains, limitation of ambient scene effective resolution even when the subtractive system is off in at least some iterations no direct view of the wearer's eyes even when the subtractive augmented reality system is switched off. Magic Leap also refers to directing ambient light to an off-axis display for modulation in patent [US20150241700 A1] and requires a separate optical system to do so. Patent [US 20140177023 A1] is another invention utilizing the diversion of ambient light to an off-axis display to create occlusion effects. A more compact LCOS-based occlusion system was implemented by Cakmakci et al. [DOI: 10.1109/ISMAR.2004.2].
SmartColor [IEEE Transactions on Visualization and Computer Graphics PP(99):1•June 2015 DOI: 10.1109/TVCG.2015.2450745] compensated the change in hue of digital graphics in an optical see-through display overlaid on a differently coloured background by using a computer vision system to capture the scene and then applying a filter of the scene's inverse colour to the digital graphics. This can create better contrasting digital graphics but is only an additive solution. The digital graphics are corrected to approximate their intended colour but to be more noticeable the overall display brightness must still be increased.
Magic Leap [US 20150243103 A1] state a more specific form of additive contrast enhancement in which they claim that the surrounding of an intended digital graphic with a blue digital colour such as in the form of an aura or rendering the digital graphic itself as blue would be perceived by the user as being a region which is darker than it actually is. The user would perceive the additive blue colour as a subtraction of light intensity. This additive solution still relies on increasing display brightness which can make for uncomfortable viewing, particularly in bright ambient conditions.

### SUMMARY OF INVENTION

The present invention uses photochromic materials or similar derivative materials to create a subtractive display to both generally block out parts of the outside world and to create virtual shadows and other graphics. The present invention uses a spatial light modulator and its projected light to spatially modulate the photochromic or derivative material, with the aid of an optical system to direct the modulating light where necessary.

Some embodiments of the present application are discussed below and address the above-identified issues. For example, one embodiment of the present disclosure is to create a display of dark pixels referred to herein as “subtractive augmented reality display” as it creates augmented reality content, particularly shadow effects and filtered color, by taking some light away whereas the standard idea of augmented reality is to create content by producing more light. The subtractive display may be achieved by addressing or modulating a material which can darken, lighten or change color directly or indirectly in response to a certain stimulating light. This can allow for the control of the material by a modified micro display system which may be the display of choice in the field of augmented reality while also getting rid of the need for many of the active display controls around the portion of the head-mounted augmented reality device which is see-through.

In one embodiment, a subtractive augmented reality display system is provided. The subtractive augmented reality display system may include one or more light emitting displays, an optical system with which the user can view the ambient scene and the light emitted from the display(s) and a material in the way of the user's line of sight to the ambient scene which changes color, darkens or lightens based on interaction with light from the display system.

### BRIEF DESCRIPTION OF DRAWINGS

Aspects of the present invention is further described in the detailed description which follows in reference to the noted plurality of drawings by way of non-limiting examples of embodiments of the present invention in which like reference numerals represent similar parts throughout the several views of the drawings and wherein:

FIG. 1A illustrates a system of an augmented reality system, in accordance with some embodiments.

FIG. 1B illustrates a system of an augmented reality system with the addition of a sensor system, in accordance with some embodiments.

FIG. 2 illustrates a side view of the physical arrangement in an embodiment of the subtractive augmented reality display system.

FIG. 3 illustrates another embodiment using waveguides to combine the augmented reality content and the ambient scene.

FIG. 4 illustrates a representation of a subtractive augmented reality display system, in accordance with some embodiments.

FIG. 5 illustrates a layout for a single panel digital liquid crystal on silicon (LCOS) picoprojector, in accordance with some embodiments.

FIG. 6A illustrates a representation of how an alpha channel works in computer image manipulation programs, in accordance with some embodiments.

FIG. 6B illustrates a representation of an analogy for the alpha channel using the light addressable material to control the transparency of the user's view to the ambient scene, in accordance with some embodiments.

FIG. 6C illustrates a system of an augmented reality system using separate optical paths, in accordance with some embodiments.

FIG. 7 illustrates a system of an augmented reality headset, in accordance with some embodiments.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

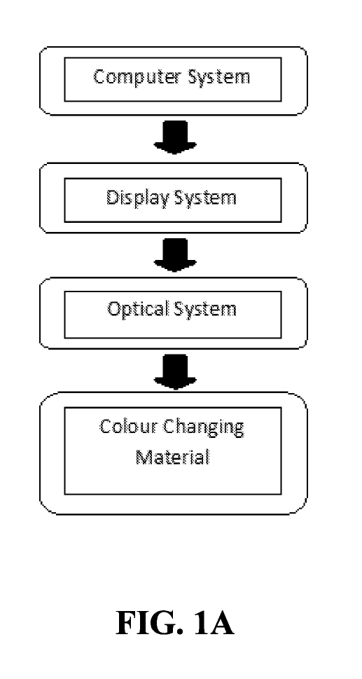

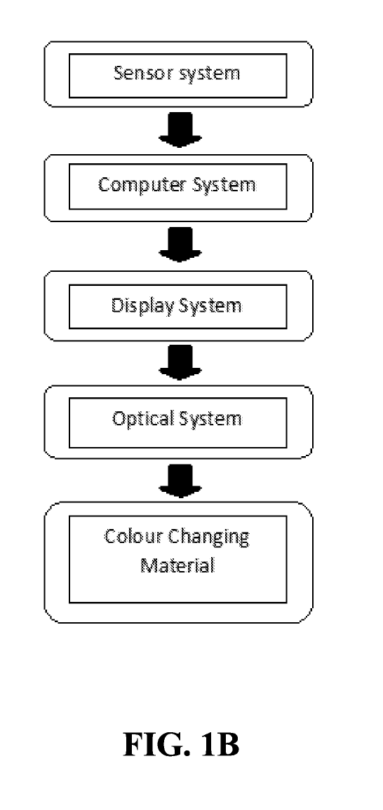

FIG. 1A shows a high level view of the overall system where a computer system controls a display system which then transmits light through an optical system at least some of which is used to modulate one or more color properties of a material in the user's field of view.

FIG. 1B shows a high level view of the overall system with the addition of a sensor system which inputs information to the computer system to better calculate appropriate control of the display system and ultimately appropriate modulation of the color changing material.

The device into which the subtractive display system is included may take the form of a head worn-device such as augmented reality glasses, an augmented reality construction helmet, an augmented reality motor vehicle helmet, an augmented reality military helmet, an augmented reality pilot helmet, augmented reality ski goggles, a vehicle heads up display (HUD), an augmented reality telescope, augmented reality binoculars or other device which is used to display information at the same time as viewing the real world.

The computer system may consist of one or more hardware components and software components. The hardware may be one or more of central processing units, graphics processing units, field programmable gate arrays, digital signal processors, random access memory, solid state memory, optical internal hard-drive, removable storage media (memory cards and CDs), application specific integrated circuits in configurations such as discrete units or one or more integrated or monolithic units such as a system on chip. The software may include firmware, drivers, an operating system, real-time operating system, services, applications, programs and scripts.

The display system may be one or more of, or a combination of, a microOLED, LCD, OLED, LED, quantum dot LED, liquid crystal on silicon (LCOS) display, ferroelectric liquid crystal on silicon (FLCOS) display, digital micro-mirror device (DMD), scanning micro-mirror, scanning fibre-optic, electro-optic beam scanning modulator, multi-gated scanning waveguide, acousto-optic beam scanning modulator, 7 segment display or other video display or light modulator. The key feature is the ability to have it operate in such a manner as to emit and modulate a light source which then modulates the light addressable color changing material.

The optical system may contain refractive lenses, diffractive lenses, mirrors, prisms, waveguides, image conduits, color filters such as hot mirrors, dielectric mirrors and bandpass filters and other elements to properly convey the display light to its proper place on the color changing material which is in the user's field of view and optionally to also convey additive color to the user such as video display. In some systems an optical system only comprises of parts within or around the display system or isn't necessary at all.

The light addressable color changing material may be a thin film coating or a substantially thick volume, a sheet, a gas or liquid trapped in place or other form. The material may change from transparent or translucent to substantially dark or black when a certain stimulating light is applied.

The material may be sensitive to only certain wavelengths and it is particularly useful when the sensitivity is restricted to a light wavelength range outside what is visible to the user. Even more useful is to have it sensitive to only ultraviolet light as this allows the infrared spectrum to be used for light sources for infrared eye-tracking methods especially if the light for the subtractive display and the light for the eye-tracking use the same optical path. The material is preferably directly sensitive to light but may be also sensitive indirectly by methods such as photo-electrochromism where a part of the material generates an electric current or electric field from the subtractive display stimulating light and then another color switching or opacity changing part is activated by this electric current or electric field. The material may be modulated to produce different degrees of filtering, opacity or transparency similar to how digital video is usually shown as grey levels. This can be achieved by the intensity of the activating light falling on the material or by the length of exposure or both.

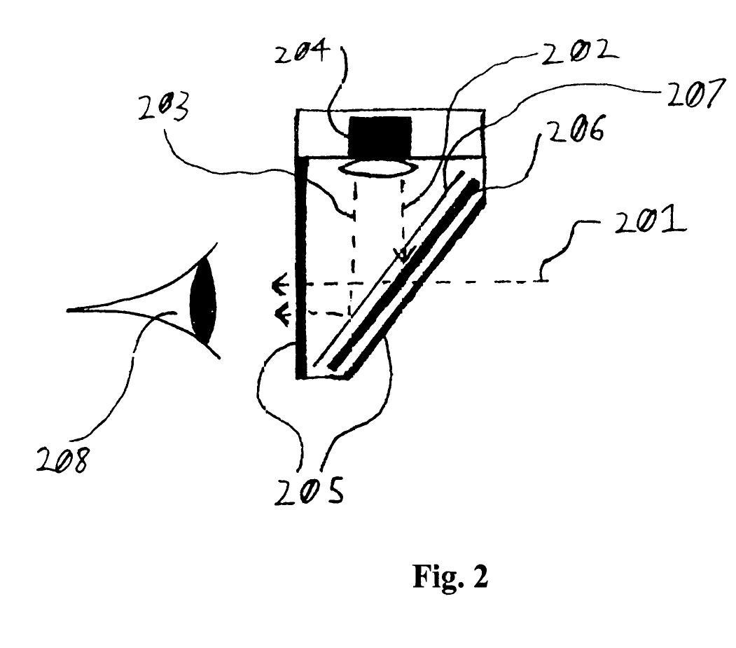

FIG. 2 illustrates a side view of the physical arrangement in an embodiment of the subtractive augmented reality display system. The arrow 201 represents the passing of light from the ambient scene through the optical system combining the subtractive content with this ambient view. The arrow 202 shows the path of the light which controls the opacity or the color of the photo-addressable coloring changing material. The arrow 203 shows the path of the visible image from the display system to the eye of the user. The display system 204 is located above the ambient scene view of the user and facing downwards. The light filters 205 used here are thin film coatings on clear substrates are used to both block light from the outside world which the photo-addressable material is sensitive to and also to block any of the controlling light for the photo-addressable material from entering the user's eye or otherwise escaping the augmented reality head-mounted display device. The photo-addressable (light addressable) material 206 which changes color such as from transparent to black is located in the way of the user's view of the ambient scene, here the color changing material is a thin film on a thin substrate. 207 is a half-silvered mirror to combine some of the intensity of the image from the display to the user's eye while also allowing the ambient light of the user's surroundings to partially pass through and for light to partially pass through which has the function of switching the color changing light addressable material. 208 represents an eye of the user.

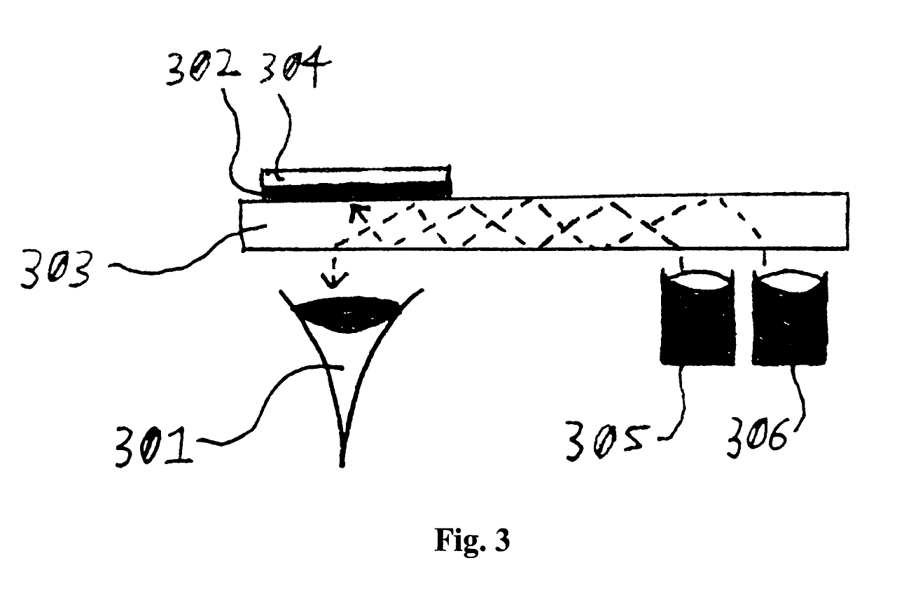

FIG. 3 illustrates another embodiment using waveguides to combine the augmented reality content and the ambient scene. 301 is the user's eye, 302 is a coating of the light addressable color changing material which in this case is a photochromic material on the back side of the waveguide to the user's eyel. 303 is the planar optical waveguide which conveys both the additive augmented reality content such as color video and the modulating light for the photochromic material to generate subtractive content such as shadows and video contrast improvement by making the waveguide less transparent at various points. 304 is an optically clear covering to protect the photochromic material. 305 is a display light source for modulating the photochromic material which has a slightly shifted optical path compared to the light from 306 which is the video light source for the additive color video augmented reality content.

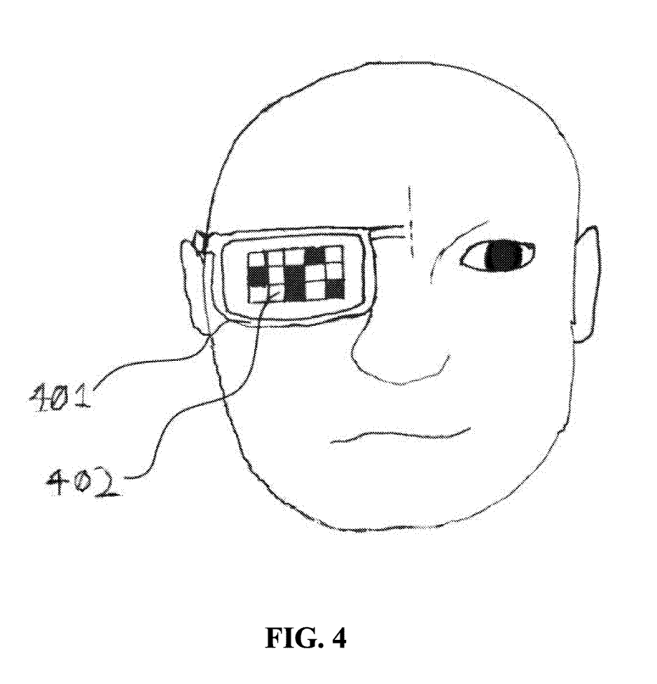

FIG. 4 illustrates a representation of the subtractive display shown as black pixels which are arbitrarily large on the users' augmented reality glasses of which half of the glasses are shown. 401 represents the augmented reality glasses and 402 represents the subtractive pixels which are shown here as being black for clarity but may be grey scale and/or different colors.

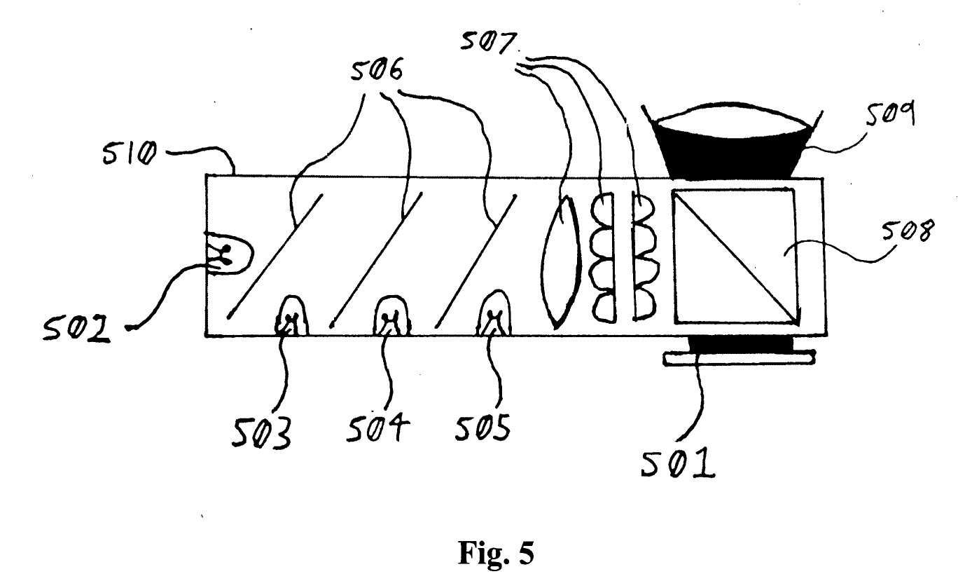

FIG. 5 illustrates a layout for a single panel digital liquid crystal on silicon (LCOS) picoprojector operating in color field sequential mode with ultraviolet light as an extra color field to stimulate the light addressable material. The color fields used in this version are red then ultraviolet then green then ultraviolet then blue then ultraviolet.

The subtractive display is ideally but not necessarily used in conjunction with additive display. Here additive display means the current video or digital content created and seen due to direct emission of light. To create the subtractive content, the computer system must process and send a new part of the video to the light addressable material. This essentially involves calculating which parts of the user's view should have shadows and which should be left blank and if and to what extent visible video pixels should have a backing to prevent ambient light moving through their image. Therefore the computer system calculates an opacity mask which may be thought of as being like the alpha channel in image editing software applications for the sake of convenience of explanation but instead the bottom layer is the ambient scene, the color changing light addressable material is the alpha channel or opacity mask and the top layer is the additive display content. The computer system addresses the display system with the additive and subtractive video or image channels. In particular it is easy to consider this as being like a four channel video, with red, green and blue for additive display and a fourth channel to address the display for opacity modulation of the light addressable material.

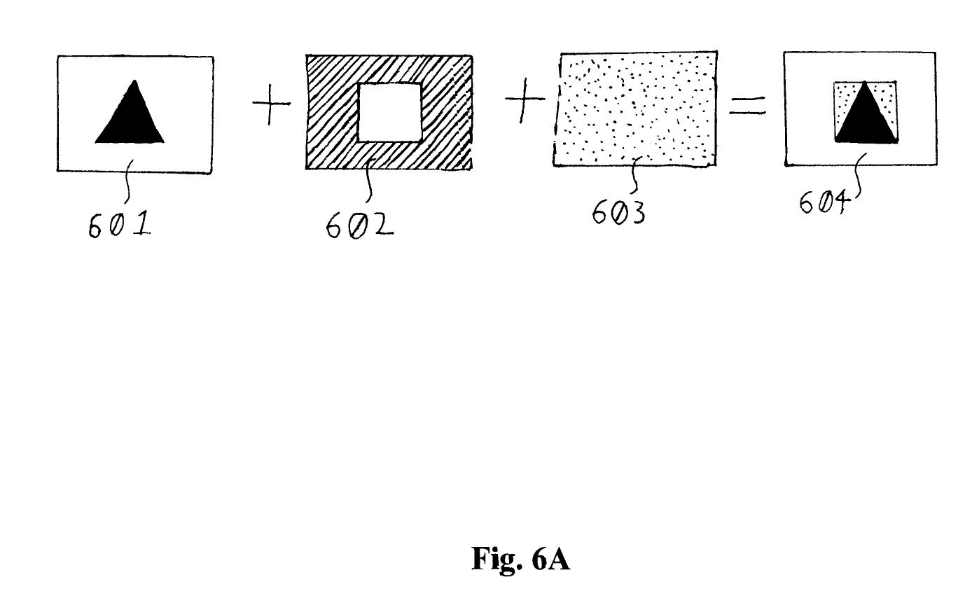

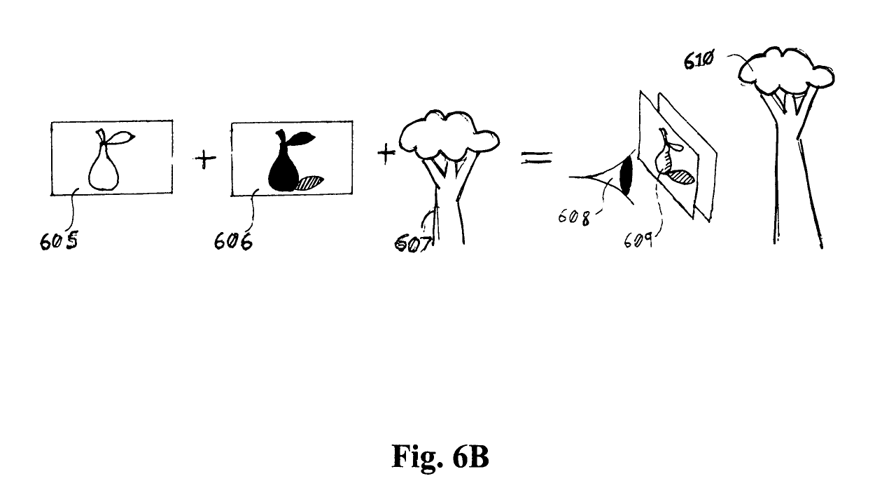

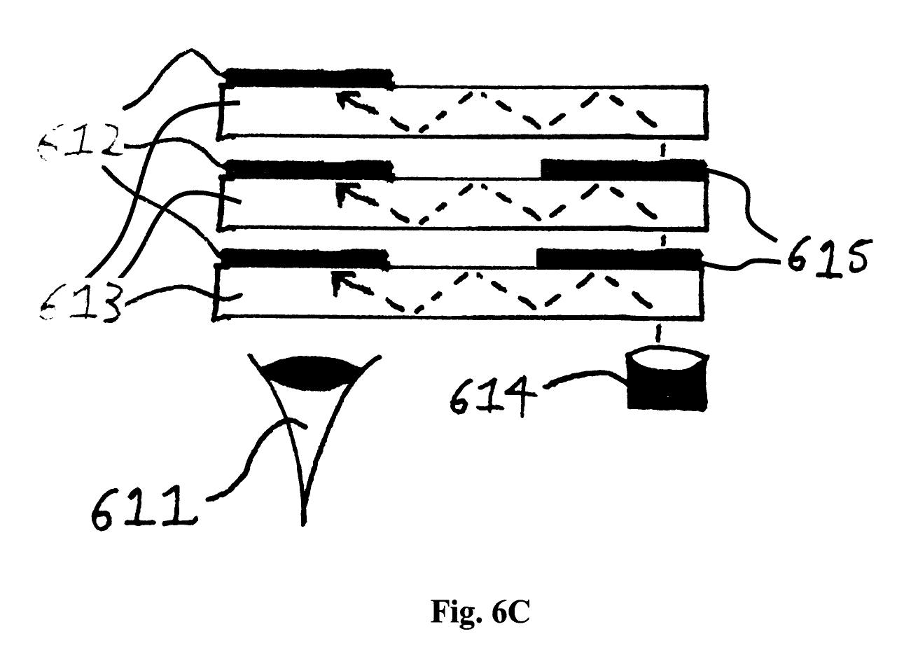

FIG. 6A illustrates a representation of how an alpha channel works in computer image manipulation programs. 601 represents the top image layer of a black triangle without a background, 602 represents the alpha channel layer which has a transparent rectangle section surrounded by an opaque frame and 603 represents the bottom layer of dots on a plain background. 604 shows that when the layers are stacked they combine so that only the dots which can pass through the rectangular transparency in the alpha channel can be seen in the final image.

FIG. 6B illustrates a representation of the analogy for the alpha channel using the light addressable material to control the transparency of the user's view to the ambient scene. 605 represents the additive augmented reality content or video which in this case is a pear, 606 represents the subtractive augmented reality content which is created by the modulation of the color changing material and is used for content like virtual shadows and improving additive content contrast, in this case it is the silhouette of the pear along with a basic shadow which is represented by the hatched ellipse shape and 607 represents the user's view of the ambient scene which in this case is a tree. 608 represents the user's eye, 609 is the combined user's view of the additive and subtractive augmented reality content which is overlaid on the user's view of the ambient scene which in this case is a tree represented by 610.

In more complex sensor system inputs particularly computer vision, the accuracy of the subtractive augmented reality content (and additive video) can be enhanced. The input of a scene depth map, whether calculated previously and then supplied to the computer system or captured in real time by computer vision aids in the calculation of how digital objects' shadows should be occluded, warp and otherwise change based on the characteristics of the scene's real objects. The use of image based lighting techniques such as the capture of high dynamic range panoramic images helps in the accurate position and intensity of virtual shadows or dark parts of the scene by calculating how the path of the light rays in the scene affect the virtual additive and subtractive content and how also these virtual objects would cast shadows or different lighting patterns over the real objects. Eye-tracking helps to determine the gaze vectors of the eyes and in some cases their position relative to the displays along with the pupil size and accommodation depending on the method used. The calculation of the geometry between the subtractive display, the ambient scene objects and the user's eyes helps to place the pattern in the right positions on the subtractive display. The three above enhancements are particularly effective when used together.

FIG. 6C shows a system which allows for the use of three alpha channels or three filters to separately control which parts of the red, green and blue regions of the visible light spectrum are obscured by using separate optical paths to address the color changing materials which absorb red, blue and green parts of the visible light spectrum, respectively and which are all sensitive to modulation by the same activating wavelength or wavelength range of light. 611 represents the user's eye, 612 are the three versions of the material each substantially blocking of the different portions of the visible light spectrum, in this case red, green and blue. 613 represents the different optical paths to deliver the modulating light source for the color changing material which in this case is photochromic material with waveguide optical paths. 614 is the source for the light which modulates the photochromic material. 615 are switchable optical elements which determine which optical path the modulating light traverses. A similar set-up which requires only one waveguide can be utilized by having a photo-electrochromic material instead of a photochromic material. Here for instance the physically separate parts of the material are each comprised of a part which will generate a photocurrent or electric field when modulated by an appropriate wavelength of light and a second part which is electrochromic and will switch color or opacity due to the photocurrent or induced electric field. In this way three source light wavelengths can travel through a single waveguide and modulate each of the red, blue and green blocking material starting with the furthest away part of the material as the other material layers the light passes through are not sensitive to that wavelength.

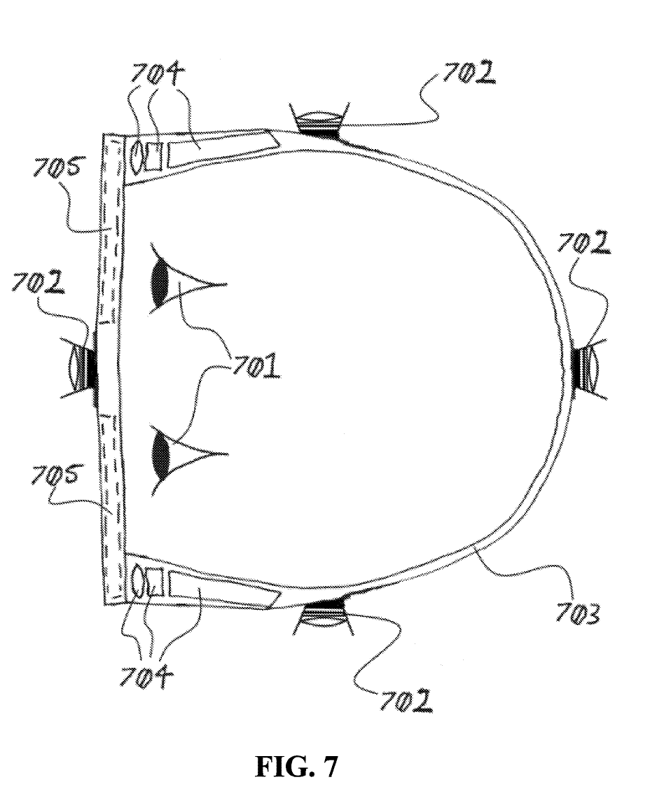

FIG. 7 illustrates a top view of an augmented reality headset with several camera modules which capture HDR images which the computer system stitches into a panoramic image for use in image based lighting to determine how the virtual shadows and other subtractive elements of virtual objects and real objects should look based on the derived light paths from the panoramic high dynamic range image. 701 represents the eyes of the user. 702 represents the locations of the high dynamic range cameras modules whose combined field of view captures all or most of the ambient scene around the user, in this case facing in four cardinal directions. 703 represents the glasses-cum-headband augmented reality wearable device. 704 represents the embedded computer system to handle the camera outputs of high dynamic range images which are stitched and analysed with image based lighting techniques and the display units and projection optics. 705 represents the optics which combine the augmented reality displays and the real world which in this case are waveguides.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

Some embodiments are discussed below:

1.-A subtractive augmented reality display system, comprising of one or more light emitting displays, an optical system with which the user can view the ambient scene and the light emitted from the display(s) and a material in the way of the user's line of sight to the ambient scene which changes colour, darkens or lightens based on interaction with light from the display system.

2a1. the material may be a photochromic material which switches colour when illuminated.

2a2. the material may be a photo-electrochromic material where a first part of the material generates a photocurrent or electric field potential when illuminated and where a second part of the material switches colour based on this photocurrent or electric field potential.

2a3. The material may be a photo-thermochromic material where a first part of the material generates heat when illuminated and where a second part of the material switches colour based on this heat.

2a4. the material may be an electro-photochromic material where the material is only sensitive to switching by light when it is also primed by an electric field or current or the absence thereof.

2b1. the material may be in a bleached or substantially transparent state by default and then switch to a coloured or darkened state when illuminated.

2b2. the material may be in a coloured or substantially darkened state by default and then switch to a bleached or transparent state when illuminated.

2c1. the relative degree of colouring or bleaching on local parts of the material may be modulated by the display to form pixels in the material.

2c2. the relative degree of colouring or bleaching on local parts of the material may be modulated by the display to form voxels in the material.

2c3. the relative degree of colouring or bleaching on local parts of the material may be modulated by the display to form diffractive interference patterns in the material.

2c4. The modulation of the material may be controlled by the length of exposure of the material to illumination from the display

2c4. The modulation of the material may be controlled by the intensity of exposure of the material to illumination

2d1. The material may be substantially more sensitive to activation (switching) by certain wavelength ranges of light than others.

2dd1. The material may be substantially more sensitive to activation by ultraviolet light than visible or infrared light

2dd2. The material may be substantially more sensitive to activation infrared light than visible light or ultraviolet light

2d2. The material may made of components which are substantially more sensitive to certain wavelengths of light than others

2d3. The material may be switched back to back to its original state by a combination of one or more of the suppression or stopping of the activating light, the use of a different wavelength or wavelength range of light, the use of heat, the use of an electric field, the use of an electric current, the saturation of the activating light beyond a threshold.

2e1. In the coloured state the material may be broadly and substantially blocking or absorbing of light in the visible spectrum to the user.

2e2. In the coloured state the material may be narrowly and substantially blocking or absorbing of light in certain regions of the visible spectrum to the user.

2ee1. the material may consist of parts each of which is narrowly and substantially blocking or absorbing of light in certain different regions of the visible spectrum to the user.

2eee1. Each part of the material of which is each substantially blocking to different parts of the visible spectrum to the user when in the coloured state may be separately addressable by different modulating wavelengths of light

2eee2. Each part of the material of which is each substantially blocking to different parts of the visible spectrum to the user when in the coloured state may be separately addressable by being placed on different substrates which are then stacked to face the user

2eeee1. The substrates hosting the parts of the material each of which is each substantially blocking to different parts of the visible spectrum to the user when in the coloured state may be separately addressable by having different paths for the controlling light to travel such as waveguides

2eeee2. The material of which parts are each substantially blocking to different parts of the visible spectrum to the user when in the coloured state may be separately addressable by having the same path for the controlling light to travel but have polarisation sensitive material and switchable polarisers between the substrates to control which part of the material is affected by the controlling light.

2eeee3. The material of which parts are each substantially blocking to different parts of the visible spectrum to the user when in the coloured state may be separately addressable by stacking each part between electrodes, having the option of using the optical path and option of the same activating light but requiring that each material layer be primed by an electric field or electric current before it may be changed by the light.

2eeeee1. This stacked layers of material may be addressed sequentially by applying the electric field or electric current to the desired layer filtering a certain portion of the visible or invisible light spectrum for the user.

3a1. The display system may be one or more of, or a combination of, a microOLED, LCD, OLED, LED, quantum dot LED, liquid crystal on silicon (LCOS) display, ferroelectric liquid crystal on silicon (FLCOS) display, digital micro-mirror device (DMD), scanning micro-mirror, scanning fibre-optic, electro-optic beam scanning modulator, multi-gated scanning waveguide, acousto-optic beam scanning modulator, 7 segment display or other video display or light modulator.

3aa1. The display system may have embedded light sources or use separate light sources such as LEDs or lasers.

3aa2. This same display system or separate display may be used to create a video conveyed to the user and the light which modulates the colouring or darkening material.

3a2. The light to modulate the darkening or colouring material may completely, partially or not at all follow the same optical path as the video image on their way to being conveyed to the user.

3b1. The light which modulates the darkening or colouring material may be shone at the same time as the light for the video image or be done in a time-multiplexing or sequential manner.

3bb1. In the case of a single panel LCOS microdisplay system using colour field time sequential illumination, the light modulating the darkening or colouring material may be turned on along with its display pattern before some of or every illumination and pattern for the video colour fields.

3c1. The display modulating the material-modulating light may use control of light intensity particularly in the case of pixel displays like microOLED, LCD, OLED, LED, quantum dot LED, liquid crystal on silicon (LCOS) display, ferroelectric liquid crystal on silicon (FLCOS) display, scanning micro-mirror, scanning fibre-optic, electro-optic beam scanning modulator, multi-gated scanning waveguide, acousto-optic beam scanning modulator, or control of light exposure time to the material particularly in the case of displays in the case of digital micro-mirror devices (DMDs), or both light intensity and exposure time, particularly suitable for single panel time-multiplexed colour field sequential LCOS, FLCOS or LCD display.

4a1. The computer system controls the display system which then modulates the darkening or colouring material.

4aa1. The computer system may be a completely local system worn or otherwise portable for the user as a single module.

4aa2. The computer system may be a completely local system with several modules with parts attached to the display system unit and other parts carried by the user and connected by cable or wireless data connection.

4aa3. The computer system may be a partially local system with some parts worn or carried by the user and other parts remotely accessed through a network connection such as the internet.

4b1. The computer system may control the display system to colour or darken a section of the material between the user's view of parts of the video and the ambient scene or outside world to improve contrast.

4c1. The computer system may calculate virtual shadows for augmented reality virtual objects and control the display system to represent them by colouring or darkening the material.

4cc1. The calculated shadows may be simple shadows corresponding solely to virtual light sources.

4cc2. The calculated shadows may be warped by the computer to correspond to the ambient scene in a natural way by having knowledge of the geometry of the ambient scene and also correspond to virtual light sources. The computer may calculate the geometry of the ambient scene and the user's relative position from a previously computed or real-time computer vision using an on-board, local or remote camera system or other sensors.

4cc3. The computer may calculate image-based lighting by using a suitable camera system such as 3 or 4 or more cameras placed around the augmented reality device or headset to record high dynamic range panoramic images or by using a high dynamic range camera with a curved mirror to capture a single image panorama which are then used with image processing to create illumination and shadowing of a virtual object based on the real world luminance and where the virtual object shadowing is created by the computer system controlling the display system to address the colour changing or darkening material.

4cc4 The computer system may use both of the ambient scene geometry and image based lighting to calculate the virtual shadows of virtual objects and virtual shadows of real objects where the shadows are displayed through the computer system's control of the display system which addresses the colouring or darkening material.

4cc5. The computer system may use a camera system or other sensor system to track the user's eye gaze to aid the calculation of the alignment geometry for the correct display of darkened parts of the colour changing or darkening material.

4ccc1. Where the colouring or darkening material has parts which filter separate bands of the visible electromagnetic in the coloured state, the computer system may use this ability to simulate the effects of light passing through virtual translucent objects such as stained glass windows, simulate the effects of virtual non-white light sources and other effects such as the reflection of a real or virtual light source off a virtual bright red wall by addressing the appropriate parts of the material through the display system.

4d1. The broadband or narrow filtering of the ambient scene by the modulation of the darkening or colouring material may be analogous to the use in computer graphics of an alpha channel which describes the opacity or transparency of a top image which in this case is the augmented reality content including effects like shadows in comparison to a bottom image which in this case is the ambient scene or outside world.

4dd1. Where the material comprises a number of parts each absorbing or blocking a different portion of the visible light spectrum to the user and separately addressable then the alpha channel can consist of separate sub-channels or multiple channels each controlling the transparency of the user's view to the ambient scene.

4ddd1. Where the material has addressable parts which block or absorb red, blue and green parts of the visible spectrum in the coloured state then the alpha channel is considered to have red, green and blue opacity masks or filters.

4dddd1. The appropriate separate blocking parts of the red, green and blue parts of the visible spectrum may be controlled by the computer graphics system where these channels are analogous to red, green and blue alpha channels or cyan, magenta and yellow subtractive channels.

What is claimed is:

1. A subtractive augmented reality display system, comprising:
one or more light emitting displays,
an optical system with which the user can view the ambient scene and the light emitted from the display(s) and
a material in the way of the user's line of sight to the ambient scene which changes color, darkens or lightens based on interaction with light from the display system.

2. The subtractive augmented reality display system of claim 1, wherein the material comprises a photochromic material which switches color when illuminated.

3. The subtractive augmented reality display system of claim 1, wherein the material comprises a photo-electrochromic material where a first part of the material generates a photocurrent or electric field potential when illuminated and where a second part of the material switches color based on this photocurrent or electric field potential.

4. The subtractive augmented reality display system of claim 1, wherein the material comprises a photo-thermochromic material where a first part of the material generates heat when illuminated and where a second part of the material switches color based on this heat.

5. The subtractive augmented reality display system of claim 1, wherein the material comprises an electro-photochromic material where the material is only sensitive to switching by light when it is also primed by an electric field or current or the absence thereof.

6. The subtractive augmented reality display system of claim 1, wherein the material is in a bleached or substantially transparent state by default and then switch to a colored or darkened state when illuminated.

7. The subtractive augmented reality display system of claim 1, wherein the material is in a colored or substantially darkened state by default and then switch to a bleached or transparent state when illuminated.

8. The subtractive augmented reality display system of claim 7, wherein the relative degree of coloring or bleaching on local parts of the material is modulated by the display to form pixels in the material.

9. The subtractive augmented reality display system of claim 7, wherein the relative degree of coloring or bleaching on local parts of the material is modulated by the display to form voxels in the material.

10. The subtractive augmented reality display system of claim 7, wherein the relative degree of coloring or bleaching on local parts of the material is modulated by the display to form diffractive interference patterns in the material.

11. The subtractive augmented reality display system of claim 1, wherein the modulation of the material is controlled by the length of exposure of the material to illumination from the display.

12. The subtractive augmented reality display system of claim 1, wherein the modulation of the material is controlled by the intensity of exposure of the material to illumination.

13. The subtractive augmented reality display system of claim 1, wherein the material is substantially more sensitive to activation (switching) by certain wavelength ranges of light than others.

14. The subtractive augmented reality display system of claim 1, wherein the material is substantially more sensitive to activation by ultraviolet light than visible or infrared light

15. The subtractive augmented reality display system of claim 1, wherein the material is substantially more sensitive to activation infrared light than visible light or ultraviolet light.

16. The subtractive augmented reality display system of claim 1, wherein the material comprises components which are substantially more sensitive to certain wavelengths of light than others.

17. The subtractive augmented reality display system of claim 1, wherein the material is switched back to back to its original state by a combination of one or more of the suppression or stopping of the activating light, the use of a different wavelength or wavelength range of light, the use of heat, the use of an electric field, the use of an electric current, the saturation of the activating light beyond a threshold.

18. The subtractive augmented reality display system of claim 1, wherein in the colored state the material is broadly and substantially blocking or absorbing of light in the visible spectrum to the user.

19. The subtractive augmented reality display system of claim 1, wherein in the colored state the material is narrowly and substantially blocking or absorbing of light in certain regions of the visible spectrum to the user.

20. The subtractive augmented reality display system of claim 1, wherein the material comprises parts each of which is narrowly and substantially blocking or absorbing of light in certain different regions of the visible spectrum to the user.

21. The subtractive augmented reality display system of claim 20, wherein each part of the material of which is each substantially blocking to different parts of the visible spectrum to the user when in the colored state may be separately addressable by different modulating wavelengths of light.

22. The subtractive augmented reality display system of claim 20, wherein each part of the material of which is each substantially blocking to different parts of the visible spectrum to the user when in the colored state may be separately addressable by being placed on different substrates which are then stacked to face the user.

23. The subtractive augmented reality display system of claim 22, wherein the substrates hosting the parts of the material each of which is each substantially blocking to different parts of the visible spectrum to the user when in the colored state may be separately addressable by having different paths for the controlling light to travel such as waveguides

24. The subtractive augmented reality display system of claim 20, wherein the material of which parts are each substantially blocking to different parts of the visible spectrum to the user when in the colored state may be separately addressable by having the same path for the controlling light to travel but have polarization sensitive material and switchable polarizers between the substrates to control which part of the material is affected by the controlling light.

25. The subtractive augmented reality display system of claim 20, wherein the material of which parts are each substantially blocking to different parts of the visible spectrum to the user when in the colored state may be separately addressable by stacking each part between electrodes, having the option of using the optical path and option of the same activating light but requiring that each material layer be primed by an electric field or electric current before it may be changed by the light.

26. The subtractive augmented reality display system of claim 25, wherein the stacked layers of material may be addressed sequentially by applying the electric field or electric current to the desired layer filtering a certain portion of the visible or invisible light spectrum for the user.

27. The subtractive augmented reality display system of claim 1, wherein the display system comprises one or more of: a microOLED, LCD, OLED, LED, quantum dot LED, liquid crystal on silicon (LCOS) display, ferroelectric liquid crystal on silicon (FLCOS) display, digital micro-mirror device (DMD), scanning micro-mirror, scanning fibre-optic, electro-optic beam scanning modulator, multi-gated scanning waveguide, acousto-optic beam scanning modulator, 7 segment display or other video display or light modulator.

28. The subtractive augmented reality display system of claim 1, wherein the display system comprises embedded light sources or use separate light sources.

29. The subtractive augmented reality display system of claim 1, wherein the same display system or separate display may be used to create a video conveyed to the user and the light which modulates the coloring or darkening material.

30. The subtractive augmented reality display system of claim 29, wherein the light to modulate the darkening or coloring material completely, partially or not at all follows the same optical path as the video image on their way to being conveyed to the user.

31. The subtractive augmented reality display system of claim 30, wherein the light which modulates the darkening or coloring material may be shone at the same time as the light for the video image or be done in a time-multiplexing or sequential manner.

32. The subtractive augmented reality display system of claim 1, wherein in the case of a single panel LCOS microdisplay system using color field time sequential illumination, the light modulating the darkening or coloring material is turned on along with its display pattern before some of or every illumination and pattern for the video color fields.

33. The subtractive augmented reality display system of claim 1, wherein the display modulating the material-modulating light uses control of light intensity in the case of a pixel display comprising: microOLED, LCD, OLED, LED, quantum dot LED, liquid crystal on silicon (LCOS) display, ferroelectric liquid crystal on silicon (FLCOS) display, scanning micro-mirror, scanning fibre-optic, electro-optic beam scanning modulator, multi-gated scanning waveguide, acousto-optic beam scanning modulator, or control of light exposure time to the material particularly in the case of displays in the case of digital micro-mirror devices (DMDs), or both light intensity and exposure time, particularly suitable for single panel time-multiplexed color field sequential LCOS, FLCOS or LCD display.

34. The subtractive augmented reality display system of claim 1, wherein a computer system controls the display system which then modulates the darkening or coloring material.

35. The subtractive augmented reality display system of claim 34, wherein the computer system is a completely local system worn or otherwise portable for the user as a single module.

36. The subtractive augmented reality display system of claim 34, wherein the computer system is a completely local system with several modules with parts attached to the display system unit and other parts carried by the user and connected by cable or wireless data connection.

37. The subtractive augmented reality display system of claim 34, wherein the computer system is a partially local system with some parts worn or carried by the user and other parts remotely accessed through a network connection such as the internet.

38. The subtractive augmented reality display system of claim 34, wherein the computer system controls the display system to color or darken a section of the material between the user's view of parts of the video and the ambient scene or outside world to improve contrast.

39. The subtractive augmented reality display system of claim 34, wherein the computer system calculates virtual shadows for augmented reality virtual objects and control the display system to represent them by coloring or darkening the material.

40. The subtractive augmented reality display system of claim 39, wherein the calculated shadows are simple shadows corresponding solely to virtual light sources.

41. The subtractive augmented reality display system of claim 39, wherein the calculated shadows are warped by the computer to correspond to the ambient scene in a natural way by having knowledge of the geometry of the ambient scene and also correspond to virtual light sources.

42. The subtractive augmented reality display system of claim 42, wherein the computer further calculates the geometry of the ambient scene and the user's relative position from a previously computed or real-time computer vision using an on-board, local or remote camera system or other sensors.

43. The subtractive augmented reality display system of claim 34, wherein the computer calculates image-based lighting by using a suitable camera system comprising a plurality of cameras placed around the augmented reality device or headset to record high dynamic range panoramic images or by using a high dynamic range camera with a curved mirror to capture a single image panorama which are then used with image processing to create illumination and shadowing of a virtual object based on the real world luminance and where the virtual object shadowing is created by the computer system controlling the display system to address the color changing or darkening material.

44. The subtractive augmented reality display system of claim 34, wherein he computer system uses both of the ambient scene geometry and image based lighting to calculate the virtual shadows of virtual objects and virtual shadows of real objects where the shadows are displayed through the computer system's control of the display system which addresses the coloring or darkening material.

45. The subtractive augmented reality display system of claim 34, wherein the computer system uses a camera system or other sensor system to track the user's eye gaze to aid the calculation of the alignment geometry for the correct display of darkened parts of the color changing or darkening material.

46. The subtractive augmented reality display system of claim 45, wherein the coloring or darkening material has parts which filter separate bands of the visible electromagnetic in the colored state, the computer system may use this ability to simulate the effects of light passing through virtual translucent objects such as stained glass windows, simulate the effects of virtual non-white light sources and other effects such as the reflection of a real or virtual light source off a virtual bright red wall by addressing the appropriate parts of the material through the display system.

47. The subtractive augmented reality display system of claim 46, wherein the broadband or narrow filtering of the ambient scene by the modulation of the darkening or coloring material may be analogous to the use in computer graphics of an alpha channel which describes the opacity or transparency of a top image which in this case is the augmented reality content including effects like shadows in comparison to a bottom image which in this case is the ambient scene or outside world.

48. The subtractive augmented reality display system of claim 1, wherein the material comprises a number of parts each absorbing or blocking a different portion of the visible light spectrum to the user and separately addressable then the alpha channel can consist of separate sub-channels or multiple channels each controlling the transparency of the user's view to the ambient scene.

49. The subtractive augmented reality display system of claim 1, wherein the material has addressable parts which block or absorb red, blue and green parts of the visible spectrum in the colored state then the alpha channel is considered to have red, green and blue opacity masks or filters.

50. The subtractive augmented reality display system of claim 1, wherein the appropriate separate blocking parts of the red, green and blue parts of the visible spectrum is controlled by the computer graphics system where these channels are analogous to red, green and blue alpha channels or cyan, magenta and yellow subtractive channels.
